(19) United States
(12) Patent Application Publication
(10) Pub. No.: US 2010/0083704 A1
(43) Pub. Date: Apr. 8, 2010

(54) METHODS AND APPARATUS FOR MANUFACTURING GLASS SHEET

(76) Inventors: Paul Richard Grzesik, Corning, NY (US); David Myron Lineman, Painted Post, NY (US); David Kenneth Vaughn, Horseheads, NY (US)

Correspondence Address: CORNING INCORPORATED, SP-TI-3-1, CORNING, NY, 14831, US

(21) Appl. No.: 12/247,400

(22) Filed: Oct. 8, 2008

(51) Int. Cl. C03B 15/02

(52) U.S. Cl. 65/51; 65/66; 65/99.3; 65/193

(57) ABSTRACT

Methods and apparatus for manufacturing glass sheets that comprise the use of platinum group metal alloy or metal-alloy-clad vessels or conduits having alloy compositions including oxidizable species capable of undergoing redox reactions with molten glass components to suppress oxygen blister formation at glass contact surfaces.

### BACKGROUND

1. Field of Invention

The present invention relates to methods and apparatus for the production of thin glass sheet such as used in the manufacture of flat panel displays and other products. More particularly, the invention provides improved methods and apparatus for the control of blister defects in high-quality drawn glass sheet for such displays.

2. Technical Background

A number of methods are known in the art for the manufacture of flat glass sheet. These include the float process, widely employed for the manufacture of glass panels for residential and automotive glazing applications, and drawing processes such as down-drawing and up-drawing that are useful for the production of glass sheet for technical applications including advanced information displays. Slot-drawing and fusion-drawing processes are examples of drawing methods preferred for the latter applications.

Compared with alternative sheet forming processes such as the float process or the slot draw process, fusion drawing produces glass sheets with surfaces of superior flatness and smoothness, and it can be employed for the production of so-called “hard” glasses with high strain points and high melting temperatures. Accordingly glasses made by the fusion process are presently preferred by many electronics manufacturers for the production of both large and small flat panel display devices, particularly including large plasma and active-matrix liquid crystal displays (AMLCDs) for televisions and computer monitors.

The basic principles of the fusion process, also referred to in the art as the overflow downdraw process, are well known and described in U.S. Pat. Nos. 3,338,696 and 3,682,609, the contents of which are incorporated herein by reference. Typical components of fusion draw apparatus include a glass melter, glass fining and conditioning components for homogenizing and removing gas bubbles from the molten glass, and a glass sheet former. Refractory conduits are additionally included for transporting the glass from the melting vessel through fining and conditioning vessels and into the sheet former. The sheet former, termed an “isopipe” in the art, typically comprises a refractory body having an upper portion incorporating an open collection trough into which the molten glass is delivered, and a lower portion for continuously shaping the feed into sheet.

In carrying out the fusion process, molten glass is delivered to the isopipe at a rate sufficient to permit it to continuously overflow the trough and to flow downwardly over the lower portions of the isopipe to form a fused glass sheet. The design of the isopipe is such that the molten glass overflows both sides of the trough simultaneously, the two resulting overflows being guided downwardly over lower isopipe surfaces where they are joined into a single sheet at the base or root of the isopipe. The inner surfaces of the two overflowing streams may be irregular due to contact with isopipe surfaces, but those surfaces fuse together and are buried in the body of the final fused sheet. The outer sheet surfaces, on the other hand, not being shaped by contact with any surface, retain high surface flatness and a pristine surface quality that is preserved in the cooled and solidified sheet product.

Many of the glasses manufactured for flat panel display applications, particularly including those formed by fusion processes, are melted, conditioned and delivered using vessel and conduit components made from, or clad with, non-reactive refractory precious metals, mainly platinum and platinum-rhodium but also other metals and metal alloys of the platinum metal group that additionally includes ruthenium, palladium, osmium, and iridium. The use of refractory precious metals such as platinum to form the glass contact surfaces of such components has been considered essential in order to avoid glass coloration, compositional inhomogeneities, and/or gaseous inclusions in the glass that can result from interactions with conventional oxide refractories. Other relatively inert metals and metal alloys, including gold, molybdenum, rhenium, tantalum, titanium, tungsten, and selected alloys thereof, have been used to provide glass contact surfaces in other branches of the glass industry.

Fining agents such as arsenic, antimony, and tin oxides have customarily been used in glass compositions for sheet-forming and other processes to aid in the elimination of bubbles from the glass. Arsenic is among the most effective fining agents known for the manufacture of technical glasses, allowing for the release of O₂ from glass melts even at glass melting and processing temperatures of 1450° C. and above. This characteristic aids in the removal of bubbles during the melting and fining stages of glass production, while a strong tendency for O₂ absorption by arsenic at lower conditioning temperatures promotes the collapse of any residual gaseous inclusions in the glass. Glass products essentially free of gaseous inclusions such as seeds and blisters can be manufactured if sufficient concentrations of these fining agents are present in the molten glass.

Nevertheless, it has become environmentally advantageous to carry out the production of glass sheet of high quality without employing arsenic or similar metallic additives as fining agents, and a number of methods and systems have been developed in the art to enable such production. Several of the latter methods have been based on the recognition that oxygen bubbling or blistering at glass contact surfaces can be caused by hydrogen migration from the glass through the platinum group metal walls of the manufacturing apparatus. For example, water or hydroxyl present in the glass can thermally decompose to hydrogen and oxygen at high temperatures, with the hydrogen thus produced rapidly permeating conduit and vessel surfaces to exit the system while leaving residual oxygen in the glass. If the partial pressures of oxygen and/or other gases adjacent glass contact surfaces exceed one atmosphere, bubble formation resulting in seeds or blisters in the finished glass product can occur. Other glass/metal oxidation reactions, occurring for example as the result of thermal cells, galvanic cells, high AC or DC current applications, or grounding conditions, can also contribute to this problem.

Among the methods that have been developed to control seed and blister formation in fusion-drawn glass sheet without the use of arsenic and antimony fining agents is the maintenance of a high dew point atmosphere around the exterior (non-glass-contact) surfaces of platinum group metal system components. The thermal breakdown of water into hydrogen and oxygen at those exterior surfaces increases the exterior partial pressure of hydrogen, reducing the rate of out-permeation of hydrogen through conduit or vessel walls to the atmosphere. Another method involves the use of a zirconia oxygen cell to generate a lower partial pressure of oxygen at the non-glass contact surface of a platinum group metal melting system. The equilibrium reaction H₂O [symbol] H₂+½O₂, is thereby shifted in a direction that increases the partial pressure of hydrogen on the non-glass contact side of the platinum system, thus decreasing the rate of out-permeation of hydrogen from the glass.

Still other methods to suppress seed and blister formation include the cathodic protection of metallic glass contact surfaces via a DC electrical current applied to the internal surfaces the delivery system. Such currents reportedly suppress oxidation reactions at delivery system surfaces. The application of hydrogen barrier coatings to the interior or exterior surfaces of platinum group metal delivery system components has proven particularly effective to slow the rate of hydrogen permeation through those surfaces. Finally, adjustments to the compositions of the glasses can reduce the potential for bubble-forming reactions, particularly including the selection of “dry” glass compositions that minimize the presence of water and hydroxyl in the molten glass.

Nevertheless, problems with these systems and methods remain. Apparatus designed to control the melting environment is often complex and involves high installation and maintenance costs, while other methods are generally not sufficiently effective to enable the production of defect-free products at large sheet sizes. Cost-effective methods for controlling blister formation in fusion-drawn glass sheet are increasingly important as advances in active matrix liquid crystal display technology continue to demand larger and larger glass sheet substrates that are nevertheless free of bubble and blister defects. The difficulty of producing larger substrates is compounded by the fact that melting and refining systems continue to employ the customary platinum and platinum alloy glass contact surfaces, which surfaces can under some circumstances actually promote rather than suppress electrochemical reactions causing blister formation at the glass/metal interface.

### SUMMARY

The present invention includes methods and apparatus for manufacturing glass products such as glass sheet that offer improved control over seed and blister formation in the glass. Moreover, these methods may be conveniently practiced in glass melting and delivery systems of the type presently used for producing drawn sheet and other products, i.e., apparatus incorporating vessels or conduits fabricated from or clad with platinum-based or other platinum group metals or alloys.

The methods and apparatus of the invention offer particular advantages for the production of high melting or high strain point glasses, e.g. those preferred for manufacturing glass substrates for flat panel display devices, in that they provide an alternative to the use of large additions of arsenic or antimony compounds to eliminate seeds and blisters from the molten glass. Further, although compatible therewith, these methods do not require the use of auxiliary equipment for the control of hydrogen pressures within the environment of the platinum-containing components of the manufacturing apparatus.

In one aspect, therefore, embodiments of the invention include methods for making a glass article that comprise the steps of melting a glass batch mixture for a silicate glass to form a molten glass, flowing the molten glass through a glass conditioning or delivery system comprising at least one conduit or vessel incorporating a glass contact surface formed predominantly of platinum group metals, and forming a glass article from the glass. In accordance with those embodiments, the platinum group metal forming the glass contact surface incorporates at least one chemical element other than the platinum group metal that is that is more easily oxidized than the platinum group metal at the temperatures of the molten glass in the system. For purposes of the present description the platinum group metal may be a single metal, or equivalently an alloy of platinum group metals.

The chemical element incorporated in the platinum group metal is present therein in a concentration sufficient to permit its diffusion from the platinum group metal into the glass. In general, that concentration will be one exceeding the equilibrium concentration for said chemical element in the platinum group metal when that metal is in contact with the molten glass at the temperatures and partial pressure of oxygen of the molten glass in the system.

The methods of the invention are applicable with particular advantage to glass sheet manufacture via the fusion process, wherein hard glasses of borosilicate, aluminosilicate or boroaluminosilicate composition, such as presently preferred for the fabrication of AMLCD information displays, predominate. Hence, in another aspect, the invention comprises methods for producing drawn glass sheet wherein a glass batch mixture for a silicate glass such as an aluminosilicate, borosilicate, or boroaluminosilicate glass is first melted to form a molten glass. The molten glass thus provided is then caused to flow through a glass conditioning or delivery system comprising at least one conduit or vessel incorporating a glass contact surface formed of a platinum-based metal alloy, and is finally drawn into glass sheet by the overflow downdraw or fusion method.

The platinum-based metal alloy forming the glass contact surface in accordance with the invention incorporates at least one oxidizable metal that participates in a redox reaction with one or more constituents of the molten glass present at the interface between the molten glass and the glass contact surface. The concentration of oxidizable metal present in the alloy will exceed the equilibrium concentration for the metal in the alloy when the alloy is in contact with the molten glass at the temperature and oxygen partial pressure of that glass in the system. The predominant redox reaction between the oxidizable metal and the glass generally comprises a chemical oxidation of the metal by oxygen present at the interface between the molten glass and the metal contact surface, thus reducing the concentration of free oxygen in the glass and oxidizable metal in the alloy.

In yet another aspect, embodiments of the invention include apparatus for the manufacture of drawn glass sheet that provides enhanced control over the formation of blisters in the glass. That apparatus includes glass melting, conditioning and delivery components for providing molten glass to a sheet forming apparatus, those components including at least one conduit or vessel incorporating a glass contact surface formed of a platinum-based metal alloy. The platinum-based metal alloy employed in apparatus according to such embodiments has a alloy composition that includes at least one oxidizable metal that will participate in at least one redox reaction with one or more constituents of a molten silicate glass while in contact therewith at a temperature in the melting or forming range for that glass. The redox reaction will typically include a chemical oxidation of the metal by oxygen present at the interface between the molten glass and the platinum-based metal alloy forming the glass contact surface.

### BRIEF DESCRIPTION OF THE DRAWINGS

The invention is further described below with reference to the appended drawings, wherein:

FIG. 1 is a schematic illustration of a representative glass manufacturing system useful for the production of drawn glass sheet;

FIG. 2 is a schematic elevational drawing modeling glass composition changes that can arise from the introduction of oxidizable elements into a molten glass stream;

FIG. 3 presents photographs comparing blister formation arising in the course of contact with two exemplary platinum group metal alloys; and

FIG. 4 presents high-temperature stress test results for two exemplary platinum group metal alloys.

### DETAILED DESCRIPTION

While the methods and apparatus herein described may be applied with particular advantage to the fusion-drawing of thin glass sheet exhibiting a reduced incidence of blisters, it will be evident that such methods and apparatus have broader utility for the production of a wide range of glass products with improved control over the suppression of seeds and blisters therein. Accordingly, the following detailed descriptions and examples, while often presented with specific reference to compositions, processes and apparatus for the fusion-drawing of such sheet, are intended to be illustrative rather than limiting.

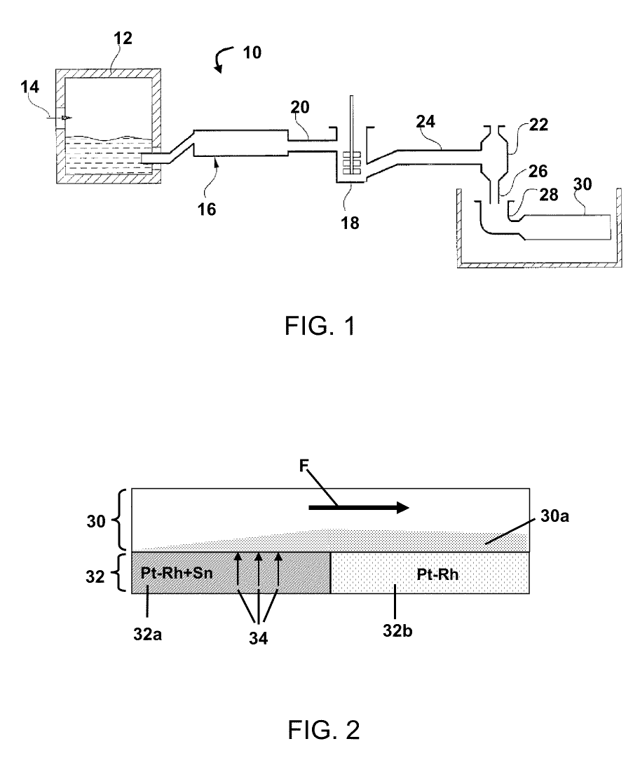

Referring more particularly to the drawings, FIG. 1 presents a schematic illustration, not in true proportion or to scale, of representative glass manufacturing apparatus 10 for the production of drawn glass sheet by an overflow downdraw or fusion process. The apparatus 10 includes a melting vessel 12 into which glass batch materials are introduced as shown by arrow 14, and wherein initial glass melting occurs. The melting vessel 12 is typically fabricated of refractory oxide materials, although it may incorporate a platinum or platinum alloy cladding for contact with the fused glass batch materials in special instances.

Apparatus 10 further incorporates molten glass processing components that are in some cases fabricated from, or clad with, platinum group metals or metal alloys, such fabrication being for the purpose of providing relatively inert contact surfaces for the processing of the molten glass. In the case of high-silica glasses such as the boroaluminosilicate glasses presently preferred for the fusion-drawing of glass sheet for information displays, the platinum group metals providing inert glass contact surfaces are typically platinum or platinum alloys such as platinum-rhodium or platinum-iridium.

Components of apparatus 10 that may be fabricated from, or fashioned to incorporate glass contact surfaces made of, inert platinum group metals include a finer tube 16, a stirring chamber 18, a finer/stirring chamber conduit or connector tube 20, a bowl 22, a stirring chamber/bowl conduit or connector 24, a downcorner 26, and an isopipe inlet conduit 28. Such components are conventional and well known in the art, finer 16 being a section designed to encourage the release of gas bubbles from the glass and stirring chamber 18 operating to homogenize the glass before its delivery through bowl 22 and downcorner 26 to inlet conduit 28 that feeds fusion isopipe 30.

The concept of deliberately including oxidizable metals or other elements in platinum group metal alloys forming glass contact surfaces in apparatus such as shown in FIG. 1 is counter to currently prevailing practice, in that chemical inertness has long been considered a primary requisite of such surfaces. Surprisingly, facilitating appropriate chemical interactions between the glass and these surfaces in accordance with embodiments of the invention, particularly in critical sections of the apparatus such as isopipe inlet conduit 12 where blister formation has been especially difficult to control, has now been found to be a highly effective approach for the suppression of such blisters.

Among the elements having utility for the direct inclusion in platinum group metals or metal alloys forming glass contact surfaces in glass manufacturing apparatus such as above described are Sn, Fe, Cu, Ni, Al, Mo, W, C, S, P and combinations thereof. Additionally, Ir and Au offer performance advantages where the platinum group metal alloy is platinum or platinum-rhodium. Metallic elements selected from these groups can be alloyed with platinum, platinum-rhodium, or other platinum group metal alloys by conventional methods known in the metallurgical arts.

Being more difficult to alloy with platinum or platinum-rhodium at substantial concentrations, elements such as carbon, sulfur and phosphorus are most effectively introduced from the metal alloys into the glass by continuous diffusion through the walls of platinum group metal vessels, conduits, or claddings. In particular, these elements may be diffused into and through such walls from reservoirs of the elements maintained in contact with the hot exterior surfaces of these platinum group metal components, or other surfaces of such vessels or conduits providing a diffusion path to the glass contact surfaces. Compounds of the elements that decompose at glass conditioning or delivery temperatures can serve as sources thereof as well.

The alloying element or elements selected for blister suppression in any particular case should not only be more oxidizable than the base platinum group metal or metal alloy into which they are introduced, but also sufficiently reactive at molten glass temperatures to be effectively oxidized through contact with the molten glass. Of course, the selection of those elements to be preferred for blister suppression in any particular glass composition system, whether for reasons of cost, suppression activity, compatibility with the base glass being manufactured or the particular platinum group metal being used in the manufacturing system, may vary with base glass composition and system configuration but in any case may readily be determined by routine experiment.

The maximum proportion of oxidizable elements to be incorporated in platinum group metal alloys forming glass contact surfaces in sheet glass manufacturing apparatus such as apparatus 10 will be limited by the particular effects of the incorporated element or elements on the thermal and chemical stability of the modified alloys. Excess amounts of some additives may reduce the refractoriness of the platinum group metal, leading in extreme cases to unacceptable reductions in system service life. Thus additive concentrations should be limited as necessary to insure that the glass contact surface containing the incorporated element(s) will have a melting temperature at least in excess of the delivery temperature of the molten glass, i.e., that temperature at which the glass is typically delivered to glass-forming apparatus such as a fusion isopipe. In any case those proportions will be naturally limited to those forming a thermally stable alloy with the platinum group metal or metal alloy.

Tin (Sn) is an example of an alloying metal with particularly good oxidation characteristics that can be alloyed with platinum and platinum-based metals such as platinum-rhodium to provide tin-platinum or tin-platinum-rhodium alloys compatible with the hard glasses preferred for information display applications. As noted above, such glasses are typically selected from the group consisting of borosilicate, aluminosilicate, and boroaluminosilicate glasses having silica contents of 60% by weight or higher. Such glasses generally have melting temperatures (i.e., 200 poise viscosity temperatures) of at least 1500° C., together with strain points greater than 630° C., more often greater than 640° C.

Tin readily participates in redox reactions with such glasses at temperatures in the melting, conditioning and delivery range of about 1000-1650° C. Thus the use of tin can enable the manufacture of fusion-drawn glass sheet from glass compositions of these types that are essentially free of arsenic and antimony fining agents

Tin offers the further advantage that it can be alloyed with platinum or platinum-rhodium alloys in tin concentrations of up to several percent by weight, these concentrations being well in excess of the equilibrium concentration of tin in such alloys when in contact with such glasses. Sn concentrations in platinum or platinum-rhodium alloys to be used for the manufacture of aluminosilicate, borosilicate, and boroaluminosilicate glasses suitably range from 0.2-5% by weight, and more typically from 1-5% by weight, especially where intended for use at locations proximate to the isopipe in fusion sheet-drawing systems. Blister suppression in such sections, e.g., within the isopipe inlet, is particularly difficult to achieve utilizing only prior art methods, but is very effective using these alloys at these tin concentrations.

Redox reactions of the kind exhibited by Sn and other readily oxidizable metals at glass processing temperatures can produce a net reduction of the oxidation state of the molten glass in a layer of glass adjacent the glass/alloy interface, and/or a layer of glass adjacent that interface that is enriched in the oxidizable metal or an oxide of the oxidizable metal. In some systems the physical properties of the thus-modified glass layer allows for the downstream migration of that layer, with the migrating layer forming a downstream barrier against blister formation even against platinum group metal contact surfaces downstream in the delivery system that do not incorporate oxidizable metal additives.

FIG. 2 of the drawing presents a schematic elevational view of the formation of such a layer. Referring more particularly to FIG. 2, molten glass stream 30 is shown traversing a metal alloy conduit wall 32 in the direction of arrow F. Alloy wall 32 is formed by a wall section 32a formed of platinum-rhodium alloyed with a small addition of tin, and a downstream wall section 32b formed of a platinum-rhodium alloy that is substantially tin-free.

As molten glass stream 30 traverses section 32a comprising the tin additive, tin from the alloy reacts with oxygen from the molten glass to form tin oxide (SnO) at the interface between the glass 30 and alloy wall 32. The tin oxide thus produced diffuses into molten glass stream 30 to produce a reduced, tin-enriched glass layer 30a. As glass stream 30 then moves downstream over platinum-rhodium section 32b, tin-enriched glass layer 30a is also carried downstream, and continues to function as a blister-suppressing buffering layer at the interface between the glass and alloy conduit 32 even though wall section 32b does not contain an oxidizable element additive.

Tin or other oxidizable metal alloying constituents introduced into glass manufacturing systems as hereinabove described are typically distributed homogeneously throughout the volume of the modified platinum group metal alloys used to fabricate selected conduit(s) and/or vessel(s) for the system. Alternatively, or in addition, however, laminar structures wherein the alloying constituent is present only in a layer covering or within a laminated vessel or conduit wall can be utilized. For example the alloying constituent could be present only the glass-contacting surface portion of the structure. Depending upon the volume of alloy used in such structures, the concentration of the oxidizable constituent(s) can then be adjusted as needed to support blister suppression over a usefully long service life.

The following illustrative example demonstrates the effectiveness of the use of modified platinum group metal alloy glass contact surfaces to control blister formation in glass manufacturing processes and equipment.

### EXAMPLE

A comparative test of oxygen bubble formation at glass contact surfaces is carried out using platinum vessels formed predominantly of Platinum 1280, a platinum-rhodium alloy consisting of 80% Pt and 20% Rh (i.e., Pt-20Rh) that is widely used in glass manufacturing on account of its high refractoriness, chemical inertness, and good resistance to deformation at high temperatures. To illustrate the effects of oxidizable element additions to that alloy, a first boat formed entirely of Pt 1280 and a second boat formed of Pt 1280 alloyed with 1.44% by weight of tin are evaluated while in contact with a molten boroaluminosilicate glass under glass manufacturing conditions.

To carry out the comparative test, cut sheets of Eagle XG glass, commercially available from Corning Incorporated, Corning, N.Y., USA, are added to fill both boats, and the boats with glass are heated to 1450° C. in a glass-melting furnace. The two boats containing the molten glass are then held at 1350° C. in a dry atmosphere for a period of 30 minutes, a time normally sufficient under the described conditions to permit substantial hydrogen migration from the glass and the development of oxygen partial pressures in excess of 1 atmosphere at the glass/crucible interfaces. The two boats containing the molten glass are then removed from the furnace, cooled, and examined.

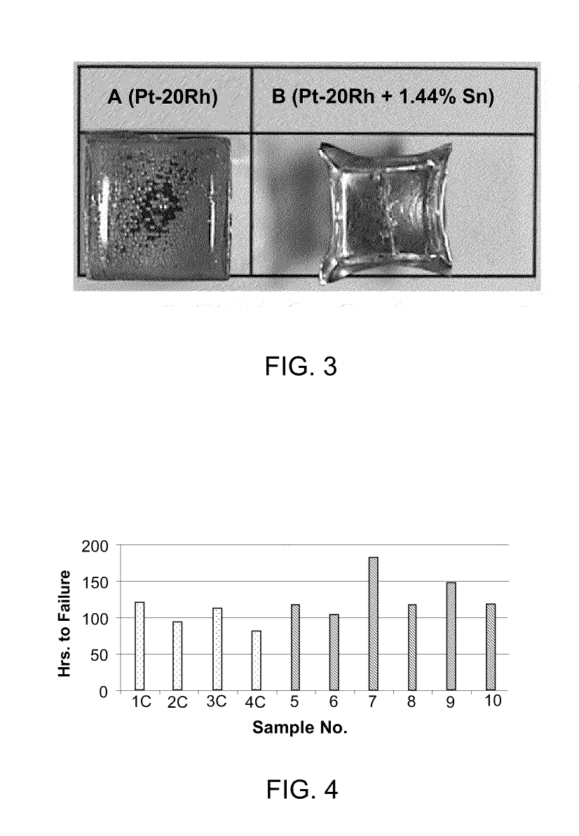

Representative results of such testing are presented in FIG. 3 of the drawings. FIG. 3 includes photographs of the glass-filled inner bottom portions of a Pt-20Rh boat (A) and a Pt-20Rh—Sn boat (B). As is evident from a comparison of those photographs, boat A exhibits extensive bubble formation within the glass, with the bubbles being concentrated at the glass/platinum interface at the bottom of the vessel. The glass and the glass/Pt—Sn interface in boat B, on the other hand, appear to be substantially clear of bubble or blister formation. We attribute the substantial elimination of blisters in the molten glass adjacent the alloy/glass interface in boat B to redox reactions between oxygen building up at the alloy/glass interface and presence of tin in the alloy of that boat, as above described.

An important advantage of the use of modified alloy glass contact surfaces rather than oxide batch additives to suppress blister formation at those surfaces is that the oxidizable elements present in the platinum group metal are effectively delivered only to the alloy/glass interface where oxygen buildup and bubble formation are most likely to occur. Targeting the point of application in this manner significantly limits the total amount of additives required for blister suppression at alloy/glass interfaces, whereas in standard manufacturing methods, the concentrations of fining agents in the molten glass must be quite high in order to effectively suppress blisters at those interfaces. Thus additive concentrations in standard molten glass streams or reservoirs are much higher in regions spaced away from glass/alloy interfaces than needed for any beneficial purpose. Further, the fact that much lower amounts of oxidizable additives are needed means that additives such as iron that might otherwise impart objectionable color to the glass are potentially useful.

Additional benefits include the fact that including oxidizable metals such as tin in platinum group metal vessels and conduits can help reduce platinum group metal costs for a given glass delivery system. Further, the use of such oxidizable metals can in some cases bring moderate increases in the strength of the resulting alloys.

FIG. 4 of the drawings presents representative results from the high-temperature stress-rupture testing of a number of platinum-rhodium alloy samples, including samples with and without a small alloying addition of tin to the base alloy. The base alloys are of Pt-20Rh composition, comprising 80% platinum and 20% rhodium by weight, with testing of the samples being carried out at a sample temperature of 1500° C. and under a tensile stress of 750 psi continuously applied to the samples. Relative sample performance in these tests is measured by the time-to-failure of each sample.

FIG. 4 reports hours-to-stress-failure for 10 alloy samples under the above conditions, comparative samples 1C-4C consisting of the base Pt-20Rh alloy and inventive samples 5-10 consisting of that alloy modified by the addition of 128 ppm (weight) of tin. The data plotted in FIG. 4 indicate a longer average time-to-failure for the samples modified by the tin additions under these testing conditions.

Data such as recorded in FIG. 4 establish the utility of even small additions of tin to platinum and platinum-rhodium alloys for the purpose of strengthening vessels and conduits to be used for the manufacture of high-silica glasses. Useful improvements are expected in platinum and platinum alloy compositions containing tin additions ranging from as little as 50 ppm to as much as 5% by weight. Thus strength benefits are provided even where the additions are too small to provide long-term protection against blister formation in alloy vessels or conduits.

The use of the above alloys conveys yet a further benefit in terms of an improved compatibility with glass or ceramic oxide coatings currently applied to selected alloy vessels or conduits in glass manufacturing systems such as described. When added to platinum group metal alloys used for vessel or conduit fabrication, oxidizable metallic elements such as tin appear to improve the adherence of glass coatings applied to the alloys to reduce hydrogen permeation therethrough. Further, the adherence and durability of oxide cement layers used to bond auxiliary heating elements or sensors to selected system components is also improved. Platinum group metal alloys including platinum and platinum-rhodium comprising from 50 ppm to 5% by weight of oxidizable metal alloy constituents are also suitable for these purposes.

The methods and apparatus hereinabove described will further reduce manufacturing system complexity and cost in that enclosures or other encapsulating means such as used in the prior art to maintain high-humidity or other blister-suppressing environments around molten-glass-containing vessels or conduits are no longer required. Continuing operational and maintenance expenses associated with HVAC systems for maintaining such environments are also avoided. Methods and apparatus employing platinum group metal alloy components that include oxidizable element additions thus offer a completely passive and low-cost approach for the control of bubbles and blisters in drawn glass sheet, and one that is broadly applicable to the manufacture of other high-quality glass products as well.

It will be apparent from the forgoing examples and descriptions that numerous variations and modifications of the specifically disclosed embodiments of the invention may be readily adapted by those skilled in the art to address particular problems or requirements of new applications without departing from the spirit or scope of the invention as set out the appended claims.

We claim:

1. A method for making a glass article comprising the steps of:
melting a glass batch mixture for a silicate glass to form a molten glass;
flowing the molten glass through a glass conditioning or glass delivery system comprising at least one conduit or vessel incorporating a glass contact surface formed predominantly of a platinum group metal or metal alloy; and
forming a glass article from the molten glass; and
wherein the platinum group metal or metal alloy is alloyed with at least one selected element that is more easily oxidized than the platinum group metal or metal alloy.

2. A method in accordance with claim 1, wherein the selected element is an oxidizable metal, and wherein the oxidizable metal is present in the platinum group metal or metal alloy in a concentration exceeding an equilibrium concentration for said selected oxidizable metal in said platinum group metal or metal alloy when said platinum group metal or metal alloy is at a temperature corresponding to a melting temperature and partial pressure of oxygen for the molten glass.

3. A method in accordance with claim 1, wherein the glass contact surface incorporating the selected element has a melting temperature in excess of a delivery temperature for the molten glass.

4. A method in accordance with claim 1, wherein the selected element is an element selected from the group consisting of Sn, Fe, Cu, Ni, Al, Mo, W, C, S, P, Ir, Au and mixtures thereof.

5. A method in accordance with claim 2, wherein the oxidizable metal is a metal selected from the group consisting of Sn, Fe, Cu, Ni, Al, Mo, W and mixtures thereof.

6. A method in accordance with claim 5, wherein the selected metal is Sn.

7. A method in accordance with claim 1, wherein the molten glass is an aluminosilicate, borosilicate, or boroaluminosilicate glass comprising at least 60% silica by weight and having a melting point of at least 1500° C.

8. A method in accordance with claim 7, wherein the glass article is a glass sheet, and wherein forming comprises down-drawing the glass sheet by a fusion process.

9. A method in accordance with claim 1, wherein the selected element is selected from the group consisting of C, S, and P, and wherein the element is continuously diffused into the platinum group metal from a source of the selected element in contact with the platinum group metal or metal alloy at locations providing diffusion paths to the glass contact surface.

10. A method for producing drawn glass sheet comprising the steps of:
melting a glass batch mixture for a silicate glass to form a molten glass;
flowing the molten glass through a glass conditioning or delivery system comprising at least one conduit or vessel incorporating a glass contact surface formed of a platinum group metal or metal alloy; and
drawing the molten glass into glass sheet; and
wherein the platinum-based metal or metal alloy incorporates at least one oxidizable metal that participates in a redox reaction with one or more constituents of the molten glass present at an interface between the molten glass and the alloy.

11. A method in accordance with claim 10, wherein the oxidizable metal is selected from the group consisting of Sn, Fe, Cu, Ni. Al, Au, Ir, Mo, W, and mixtures thereof, and is present in the platinum-based metal or metal alloy in a concentration exceeding an equilibrium concentration for said metal when in contact with the molten glass at a temperature corresponding to the temperature of the molten glass.

12. A method in accordance with claim 10, wherein the redox reaction comprises a chemical oxidation of the metal by oxygen present at the interface.

13. A method in accordance with claim 12, wherein a product of the redox reaction is a layer of glass adjacent the glass contact surface that is enriched in the metal or an oxide of the metal.

14. A method in accordance with claim 10, wherein the redox reaction results in a net reduction of the oxidation state of the molten glass in a layer of glass adjacent the interface.

15. A method in accordance with claim 14, wherein the layer of glass forms a barrier against blister formation at locations in the glass conditioning or delivery system that are downstream from the glass contact surface incorporating the oxidizable metal.

16. A method in accordance with claim 10, wherein a result of the redox reaction is a substantial elimination of blisters in the molten glass adjacent the interface.

17. A method in accordance with claim 10, wherein the conduit or vessel is a laminar structure, and wherein the oxidizable metal is present only in a metal layer covering or within the laminar structure.

18. A glass manufacturing system for the manufacture of drawn glass sheet including a glass conditioning or delivery system for the delivery of a molten glass to a sheet forming apparatus, wherein
the glass conditioning or delivery system comprises at least one conduit or vessel incorporating a glass contact surface formed of a platinum group metal or metal alloy, and
the platinum group metal or metal alloy has a composition that includes at least one oxidizable metal that participates in a redox reaction with one or more constituents of the molten glass at an interface between the glass and the platinum group metal or metal alloy.

19. A glass manufacturing system in accordance with claim 18, wherein the oxidizable metal is tin, and wherein the tin is present in the platinum group metal or metal alloy in a concentration in the range of 50 ppm to 5% by weight.

20. A glass manufacturing system in accordance with claim 18, wherein the glass sheet-forming apparatus includes a fusion isopipe, wherein the at least one conduit or vessel includes an isopipe inlet conduit, and wherein tin is present in the platinum group metal or metal alloy glass contact surface of the isopipe inlet conduit in a concentration in the range of 1-5% by weight.
